(19) United States
(12) Patent Application Publication
(10) Pub. No.: US 2011/0053549 A1
(43) Pub. Date: Mar. 3, 2011

(54) CAR STEREO UNIT WITH REMOVABLY COUPLED MOBILE COMMUNICATION DEVICE

(76) Inventor: Chin Te LAI, Taipei City (TW)

(21) Appl. No.: 12/548,188

(22) Filed: Aug. 26, 2009

(51) Int. Cl. H04B 1/06; H04B 1/00

(52) U.S. Cl. 455/345; 381/86

(57) ABSTRACT

A car stereo unit with removably coupled mobile communication device includes a supporting enclosure having a first receiving space at a front portion thereof and being internally provided with an amplifier electrically connected to a built-in car stereo system; an intermediate mount removably received in the first receiving space and electrically connected to the amplifier and a power supply module in the supporting enclosure, and having a second receiving space at a front portion thereof; and a mobile communication device pivotally and removably coupled to and received in the second receiving space to electrically connect to the intermediate mount and the supporting enclosure. The mobile communication device is internally provided with a control unit having at least a multimedia player module for outputting AV signals. With these arrangements, the mobile communication device can be used in a car as a multimedia player and be charged at the same time.

### FIELD OF THE INVENTION

The present invention relates to a car stereo unit with removably coupled mobile communication device, and more particularly to a car stereo unit having a removable intermediate mount, so that the car stereo unit is adaptable to different types of mobile communication devices by changing the intermediate mount.

### BACKGROUND OF THE INVENTION

Following the quick development in the electronic industry, various kinds of electronic products integrating multiple functions are constantly developed and introduced into the market to satisfy consumers' demands for novel and improved products. For example, the conventional car stereo system mounted in a car generally includes a head unit and a control panel. On the control panel, there are provided some control buttons and a display for showing information about the audio contents to be played. Inside the car stereo head unit, there are provided a radio, a cassette tape deck, and a compact disk (CD) player.

The conventional car stereo system allows a driver and passengers to receive broadcast and play back music during the boring driving. However, the conventional car stereo system with such simple functions can no longer meet the consumers' requirement.

To satisfy consumers, most currently available car stereo systems are multifunctional and have integrated various kinds of playing devices into the head unit, such as a radio, a CD player, a DVD player, an MP3 player, and a TV player. Frequently, the current car stereo system also integrates a mobile communication device, such as a mobile phone. Further, the current car stereo system can also have a display device externally connected thereto for playing films. Such display device can also be used to play TV channels and DVD or CD movie and video. When the car stereo system is directly connected to a mobile communication device, the driver can talk with a caller in the car without the need of holding a mobile phone to endanger safe driving.

The above-described multifunctional car stereo system is installed in the car as a whole and can only be used in the car. However, for most people, they usually drive a car only when they go to work and go back home or when they have a holiday trip. That is, people do not use the car stereo system in most of the time. Further, the relatively expensive car stereo system often becomes a target of thieves. Another disadvantage of the conventional multifunctional car stereo system integrating a mobile communication device is that the mobile communication device is determined by the car stereo system manufacturer. A user who buys the car stereo system has to also buy an additional mobile communication device that can be used with the car stereo system. That is why the above multifunctional car stereo system fails to attract general consumers. It is therefore desirable to improve the conventional car stereo systems.

### SUMMARY OF THE INVENTION

A primary object of the present invention is to provide a car stereo unit with a removably coupled mobile communication device. The mobile communication device is internally provided with a control unit having at least a multimedia player module for outputting audio and visual (AV) signals, and can be electrically connected to and work with a built-in car stereo system to serve as a multimedia player while being charged at the same time in a car, allowing the mobile communication device to have widened applicability.

Another object of the present invention is to provide a car stereo unit that can have a holder externally connected thereto for mounting a global positioning system (GPS) navigator device thereto.

A further object of the present invention is to provide a car stereo unit that can have an operation control module externally connected thereto for a user to conveniently control the operations and functions of the car stereo unit by manipulating the operation control module.

To achieve the above and other objects, the car stereo unit with a removably coupled mobile communication device according to a preferred embodiment of the present invention includes:

a supporting enclosure for installing in a car behind a dashboard thereof, the supporting enclosure being inward recessed at a front portion to provide a first receiving space and internally provided with a power supply module as well as an amplifier connected to a car stereo system built in the car; a connector being provided in the first receiving space to electrically connect with the amplifier and power supply module; and a first spring fastener assembly being provided on a first side wall of the supporting enclosure adjoining the first receiving space to locate at one side of the connector;

an intermediate mount having a size corresponding to that of the first receiving space and being removably assembled to and held in the first receiving space via the first spring fastener assembly; the intermediate mount being provided on a back wall thereof with a mating connector corresponding to and electrically connected to the connector on the supporting enclosure, and being formed at a front portion thereof with a second receiving space; a second spring fastener assembly being provided on a third side wall of the intermediate mount adjoining the second receiving space, and a pivotable coupler being provided on a fourth side wall of the intermediate mount opposite to the third side wall and the second spring fastener assembly and electrically connected to the mating connector; and

a mobile communication device being removably assembled to and received in the second receiving space of the intermediate mount, the mobile communication device being provided on one end with a socket for electrically connecting to the pivotable coupler, and on another end opposite to the socket with a locating slot for engaging with the second spring fastener assembly; the mobile communication device being internally provided with a control unit electrically connected to the socket, and the control unit having at least a multimedia player module, which works with the amplifier inside the supporting enclosure to output sound, so that the built-in car stereo system produces a sound source.

The second receiving space formed on the intermediate mount can be differently sized and shaped to adapt to differently-sized mobile communication devices, allowing convenient assembling and removing of the mobile communication device to and from the second receiving space.

In a preferred embodiment, the first spring fastener assembly includes a first spring plate located in the first receiving space on the first side wall and a first push button located on a front end surface of the first side wall; the first spring plate being provided to retain the intermediate mount to the first receiving space, and the first push button, when being pushed, pressing against the first spring plate to release the first spring plate from the intermediate mount. Therefore, the first spring plate and the first push button together form a fastening mechanism.

The second spring fastener assembly includes a second spring plate located in the second receiving space and a second push button located on a front end surface of the third side wall; the second spring plate being provided to retain the mobile communication device in the second receiving space, and the second push button, when being pushed, pressing against the second spring plate to release the second spring plate from the mobile communication device. Therefore, the second spring plate and the second push button together form another fastening mechanism.

The mobile communication device has a display and a plurality of keys provided on a front face thereof, so that a user can operate the keys to control the control unit of the mobile communication device. In another preferred embodiment, the mobile communication device is provided on the front face with a display, which includes a display panel and a touch panel, allowing a user to touch control the control unit of the mobile communication device via the display.

The control unit of the mobile communication device further includes a multifunctional module as a combination of at least any two of a digital image player module, a digital data processor module, a broadcast receiver module, a mobile communication module, and a Bluetooth communication module. The pivotable coupler on the intermediate mount and the socket on the mobile communication device are implemented as corresponding connection interfaces selected from the group consisting of a universal serial bus (USB) interface and an IEEE 1394 interface. The supporting enclosure has a second side wall opposite to the first side wall, and the second side wall externally defines a connecting face, on which a locating unit and a connector unit electrically connected to the connector are provided at predetermined positions.

In an operable embodiment, the car stereo unit further includes an operation control module, which is provided with a groove corresponding to the locating unit and a mating connector unit corresponding to the connector unit, such that the operation control module can be assembled to the supporting enclosure through engagement of the groove and the mating connector unit with the locating unit and the connector unit, respectively, and electrically connected to the connector unit and accordingly the mobile communication device, allowing a user to control the player functions of the mobile communication device via the operation control module.

In another operable embodiment, the car stereo unit further includes a holder, which is assembled to the connecting face of the supporting enclosure via the locating unit and the connector unit for holding a global positioning system (GPS) navigator device thereto. The holder includes a circular supporting seat screwed thereto, and the circular supporting seat has a smooth and flat locating face, to where the navigator device is attached by way of vacuum suction.

In an operable embodiment, the car stereo unit further includes a display device, which is assembled to the connecting face of the supporting enclosure via the locating unit and the connector unit, and has a touch display panel and a group of external insertion slots. The touch display panel allows a user to touch it for controlling different operations or functions of car stereo unit, and the group of external insertion slots is located below the touch display panel. And, the group of external insertion slots includes more than one memory card slot and more than one connection socket.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a car stereo unit with removably coupled mobile communication device according to a preferred embodiment of the present invention;

FIG. 2 is an exploded view of FIG. 1;

FIG. 3 shows a movable communication device is removably connected to a pivotable coupler included in the present invention;

FIG. 4 is a perspective view showing another type of mobile communication device is coupled to the car stereo unit of FIG. 1;

FIG. 5 shows intermediate mounts with differently sized and shaped receiving space are usable with the present invention;

FIG. 6 is an exploded perspective view showing the present invention is connectable to an operation control module;

FIG. 7 is an assembled view of FIG. 6;

FIGS. 8 and 9 show differently designed operation control modules can be connected to the present invention;

FIG. 10 shows the present invention is connectable to a holder; and

FIG. 11 is a perspective view of a car stereo unit with removably coupled mobile communication device according to another preferred embodiment of the present invention.

### DETAILED DESCRIPTION OF THE PREFERRED EMBODIMENTS

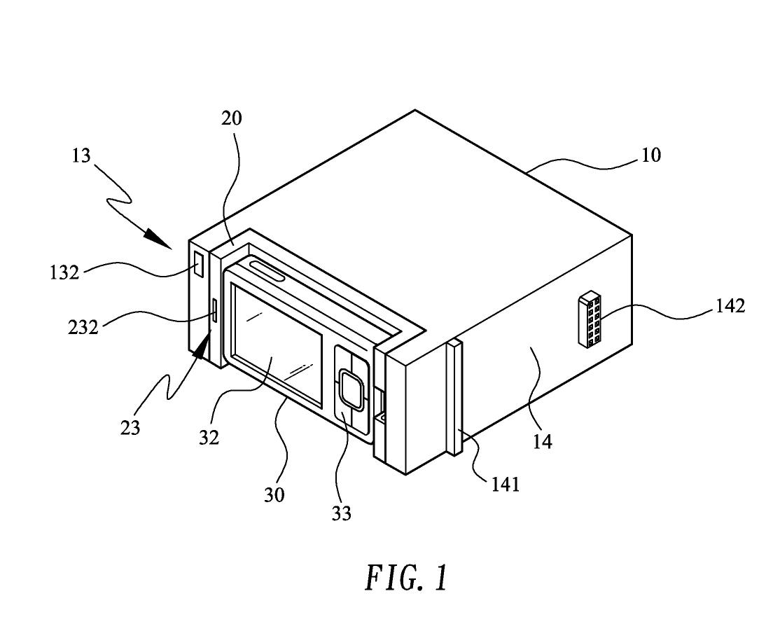

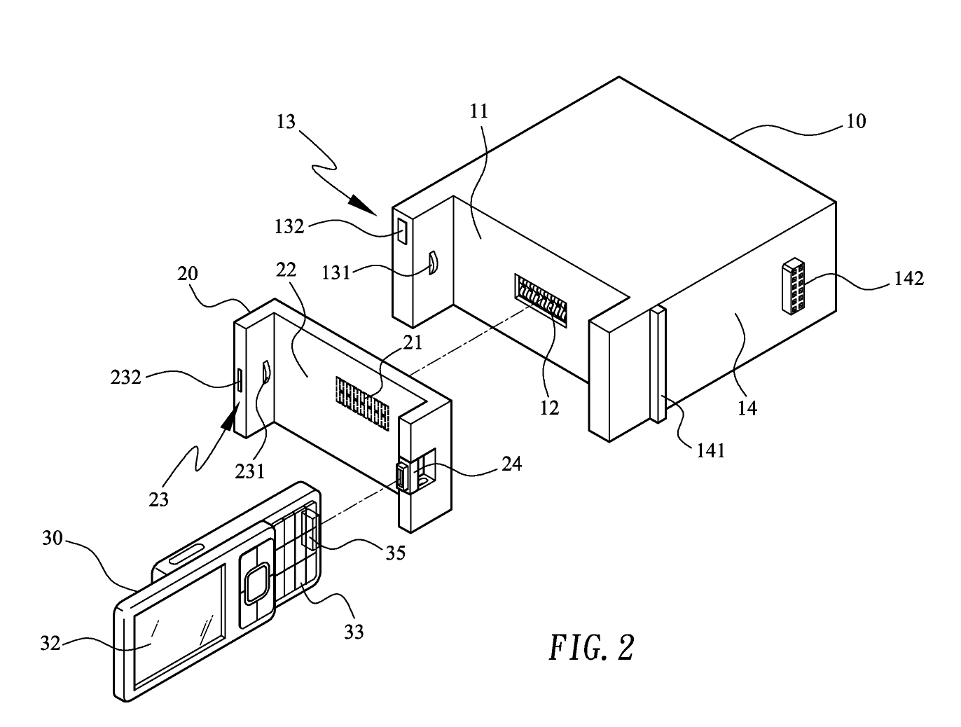

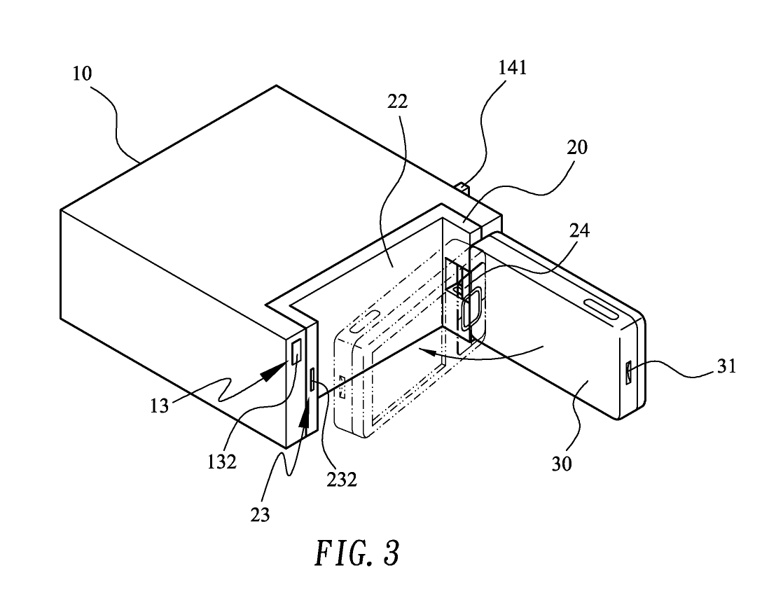

Please refer to FIGS. 1, 2 and 3, in which a car stereo unit with removably coupled mobile communication device according to a preferred embodiment of the present invention is shown. For the purpose of conciseness, the present invention will also be briefly referred to as the car stereo unit herein. As shown, the car stereo unit of the present invention includes a supporting enclosure 10 for mounting behind a dashboard of a car, an intermediate mount 20 removably assembled to the supporting enclosure 10, and a mobile communication device 30 removable coupled to the intermediate mount 20.

The supporting enclosure 10 is inward recessed at a front portion thereof to provide a first receiving space 11, and is internally provided with a power supply module (not shown) and an amplifier that can be connected to a built-in car stereo system on a car. In the first receiving space 11, there is provided a connector 12 electrically connected with the amplifier and the power supply module inside the supporting enclosure 10. A first spring fastener assembly 13 is provided on a first side wall of the supporting enclosure 10 adjoining the first receiving space 11 to locate at one side of the connector 12.

In an operable embodiment of the present invention, the first spring fastener assembly 13 includes a first spring plate 131 located in the first receiving space 11 on the first side wall and a first push button 132 located on a front end surface of the first side wall. The first spring plate 131 is provided to retain the intermediate mount 20 in the first receiving space 11 of the supporting enclosure 10. The first push button 132, when being pushed, presses against the first spring plate 131 to release the first spring plate 131 from the intermediate mount 20. Therefore, the first spring plate 131 and the first push button 132 together form a first fastening mechanism to enable fast connection and release of the intermediate mount 20 to and from the supporting enclosure 10.

The intermediate mount 20 is sized and shaped corresponding to the first receiving space 11 and is removably assembled to and held in the first receiving space 11 via the first spring fastener assembly 13 provided on the supporting enclosure 10. The intermediate mount 20 is provided on a back wall thereof with a mating connector 21 corresponding to the connector 12 in the first receiving space 11 for electrically connecting via the connector 12 to the amplifier and the power supply module inside the supporting enclosure 10. A front portion of the intermediate mount 20 is formed into a second receiving space 22 corresponding to the size of the mobile communication device 30. A second spring fastener assembly 23 is provided on a third side wall of the intermediate mount 20 adjoining the second receiving space 22, and a pivotable coupler 24 is provided on a fourth side wall of the intermediate mount 20 opposite to the third side wall and the second spring fastener assembly 23. The pivotable coupler 24 is electrically connected to the mating connector 21.

In an operable embodiment of the present invention, the second spring fastener assembly 23 includes a second spring plate 231 located in the second receiving space 22 on the third side wall and a second push button 232 located on a front end surface of the third side wall. The second spring plate 231 is provided to retain the mobile communication device 30 in the second receiving space 22. The second push button 232, when being pushed, presses against the second spring plate 231 to release the second spring plate 231 from the mobile communication device 30. Therefore, the second spring plate 231 and the second push button 232 together form a second fastening mechanism.

The mobile communication device 30 is provided on one end with a socket 35 for electrically connecting to the pivotable coupler 24, and on another end opposite to the socket 35 with a locating slot 31 for engaging with the second spring plate 231. The mobile communication device 30 is internally provided with a control unit electrically connected to the socket 35, and the control unit has at least a multimedia player module, which is used with the amplifier inside the supporting enclosure 10 to output sound, so that the built-in car stereo system produces sound.

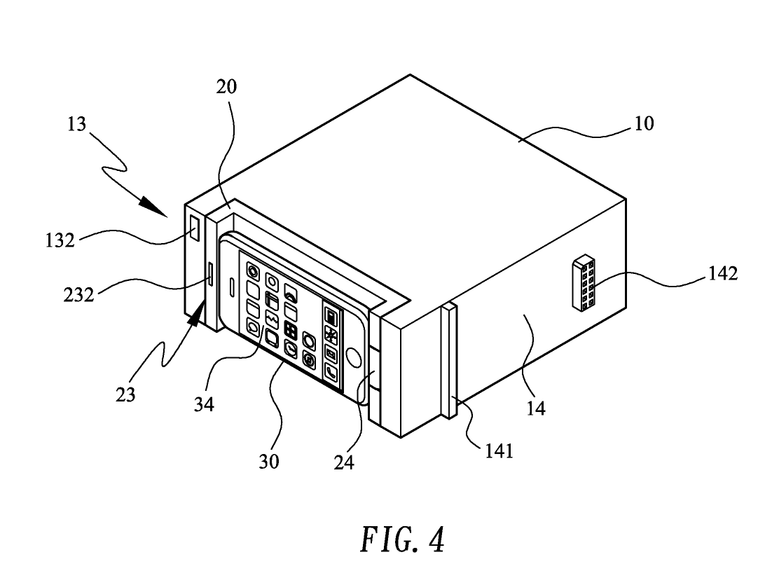

In a preferred embodiment of the present invention, the mobile communication device 30 has a display 32 and a plurality of keys 33 provided on a front face thereof, so that a user can operate the keys to control the control unit. Please refer to FIG. 4. In another preferred embodiment of the present invention, the mobile communication device 30 is provided on the front face with a display 34, which includes a display panel and a touch panel, allowing a user to touch and control the control unit via the display 34.

In a most preferred embodiment of the present invention, the control unit further includes a multifunctional module as a combination of at least any two of a digital image player module, a digital data processor module, a broadcast receiver module, a mobile communication module, and a Bluetooth communication module.

In a preferred embodiment of the present invention, the pivotable coupler 24 on the intermediate mount 20 and the socket 35 on the mobile communication device 30 are implemented as corresponding universal serial bus (USB) interfaces for transmitting a multimedia sound signal from the mobile communication device 30 to the amplifier, and further to the built-in car stereo system for playing. In a further preferred embodiment, the pivotable coupler 24 and the socket 35 are implemented as corresponding IEEE 1394 interfaces. However, it is understood the above described embodiments are only for exemplification and in no way intended to restrict the present invention. That is, the pivotable coupler 24 and the socket 35 can be implemented as any corresponding terminals for electrically connecting to each other.

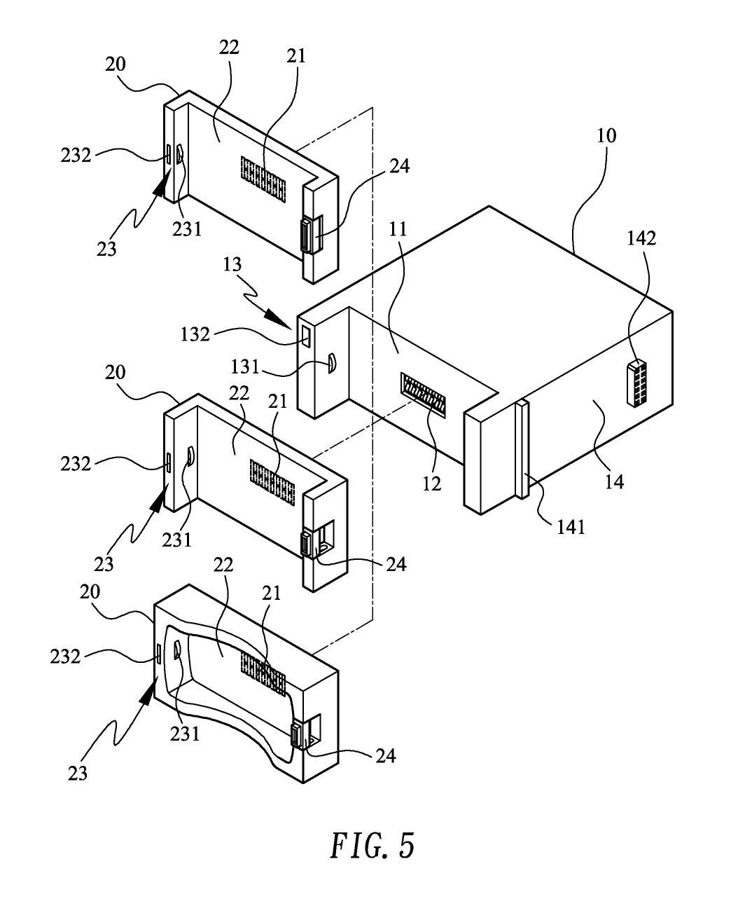

Please refer to FIG. 5. The present invention is characterized in that the amplifier inside the supporting enclosure 10 does not directly output multimedia audio and visual (AV) signals. Instead, the amplifier is first connected to the mobile communication device 30, and the multimedia player module built in the mobile communication device 30 processes and then transmits any multimedia sound source to the amplifier, at where the processed multimedia sound source is converted into a multimedia sound source that can be played via the built-in car stereo system. Since there are various types of mobile communication devices and it is desirable that the present invention is adaptable to all these different mobile communication devices 30, the intermediate mount 20 is provided between the supporting enclosure 10 and the mobile communication device 30. With this arrangement, any one of differently designed mobile communication devices 30 can be directly used with the built-in car stereo system to achieve the purpose of outputting multimedia AV contents while the mobile communication device 30 is charged via the power supply module.

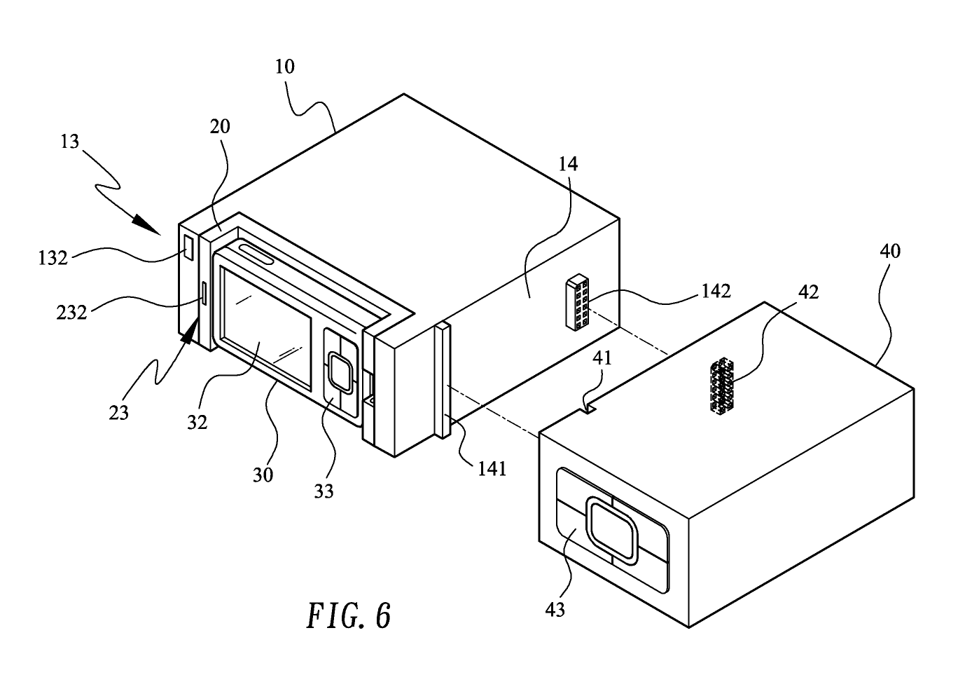

Please refer to FIG. 6. In another preferred embodiment of the present invention, the supporting enclosure 10 has a second side wall opposite to the first side wall thereof. The second side wall of the supporting enclosure 10 externally defines a connecting face 14, on which a locating unit 141 and a connector unit 142 electrically connected to the connector 12 are provided at predetermined positions, allowing the supporting enclosure 10 to be further externally connected with an operation control module 40 that allows a user to conveniently manipulate. The operation control module 40 is provided with a groove 41 corresponding to the locating unit 141 and a mating connector unit 42 corresponding to the connector unit 142, such that the operation control module 40 assembled to the supporting enclosure 10 through engagement of the groove 41 and the mating connector unit 42 with the locating unit 141 and the connector unit 142, respectively, is electrically connected to the mobile communication device 30, allowing a user to control the play function of the mobile communication device 30 via the operation control module 40.

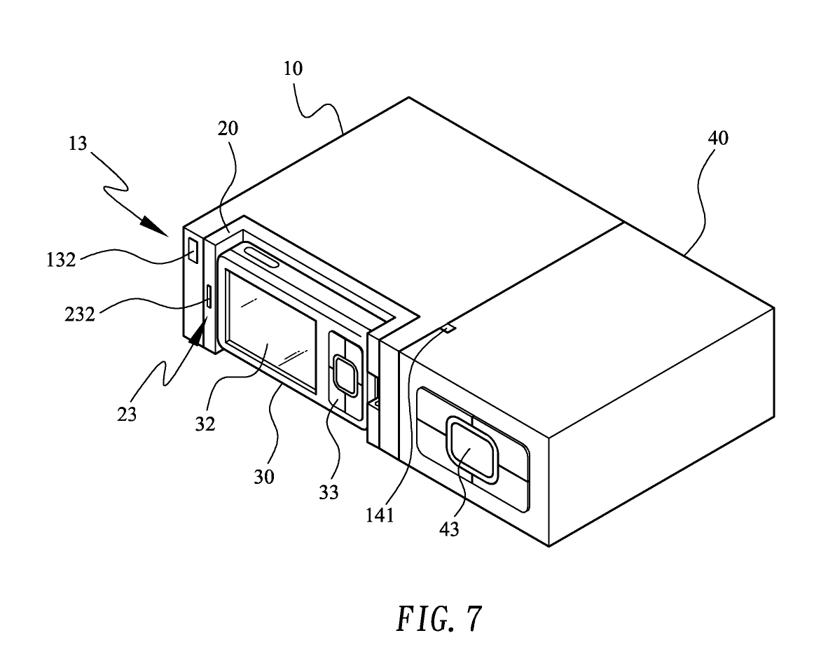

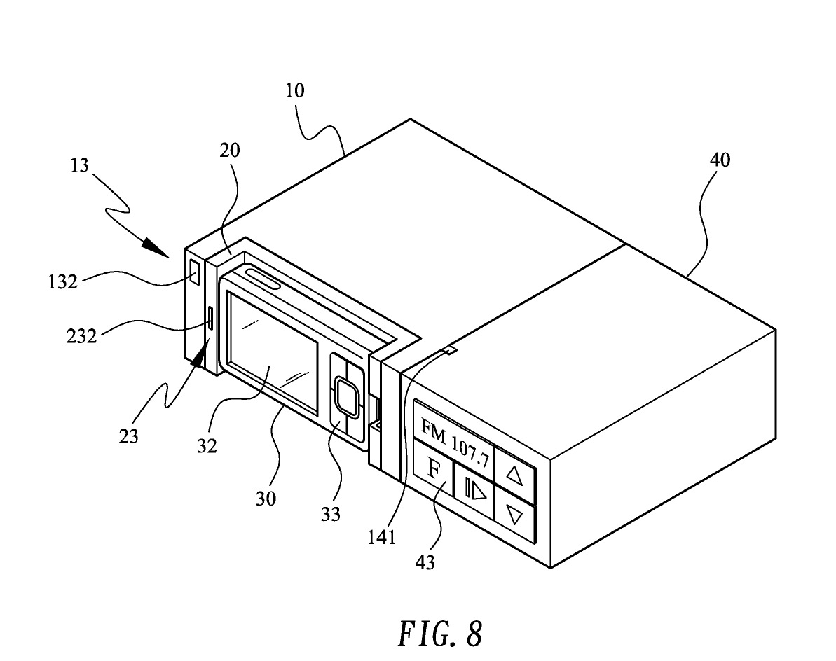

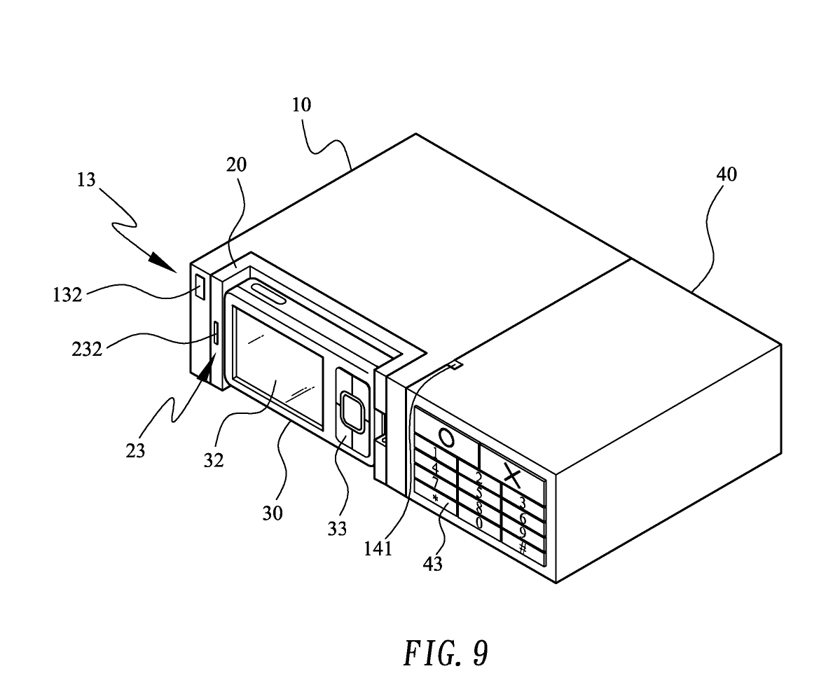

In an embodiment as shown in FIG. 7, the operation control module 40 has a control face 43 implemented as a set of function keys corresponding to the keys 33 on the mobile communication device 30. In another embodiment as shown in FIG. 8, the control face 43 of the operation control module 40 is implemented as a set of control keys for switching among different broadcasting channels. In a further embodiment as shown in FIG. 9, the control face 43 of the operation control module 40 is implemented as a set of number entry keys.

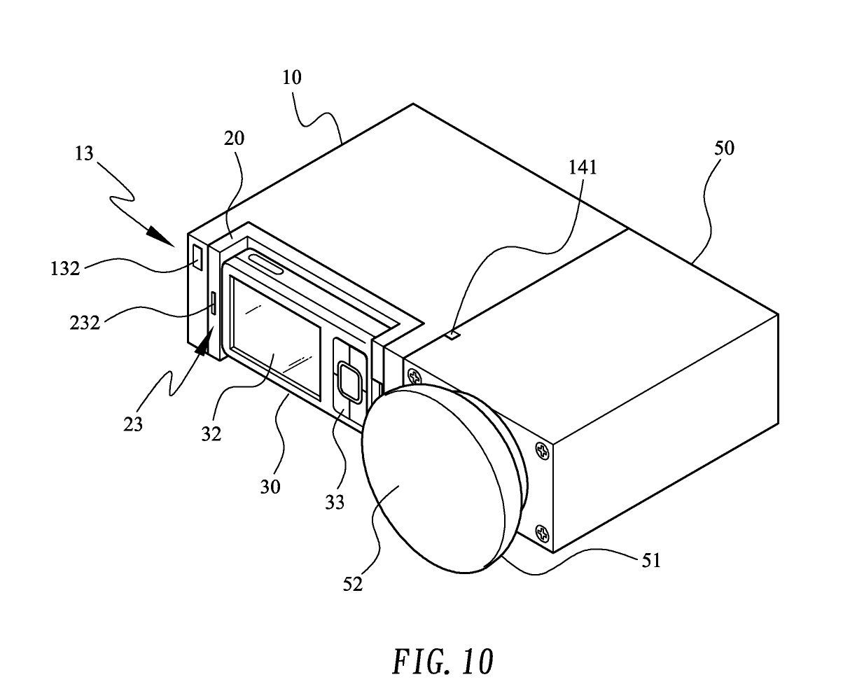

Please refer to FIG. 10. In another preferred embodiment of the present invention, the supporting enclosure 10 can be otherwise connected at the connecting face 14 to a holder 50. The holder 50 is provided with a locating groove (not numbered) corresponding to the locating unit 141 and a mating connector unit (not shown) corresponding to the connector unit 142. A circular supporting seat 51 can be screwed to the holder 50 and has a smooth and flat locating face 52, so that a navigator device with global positioning system (GPS) (not shown) can be attached to the circular supporting seat 51 by way of vacuum suction, for example.

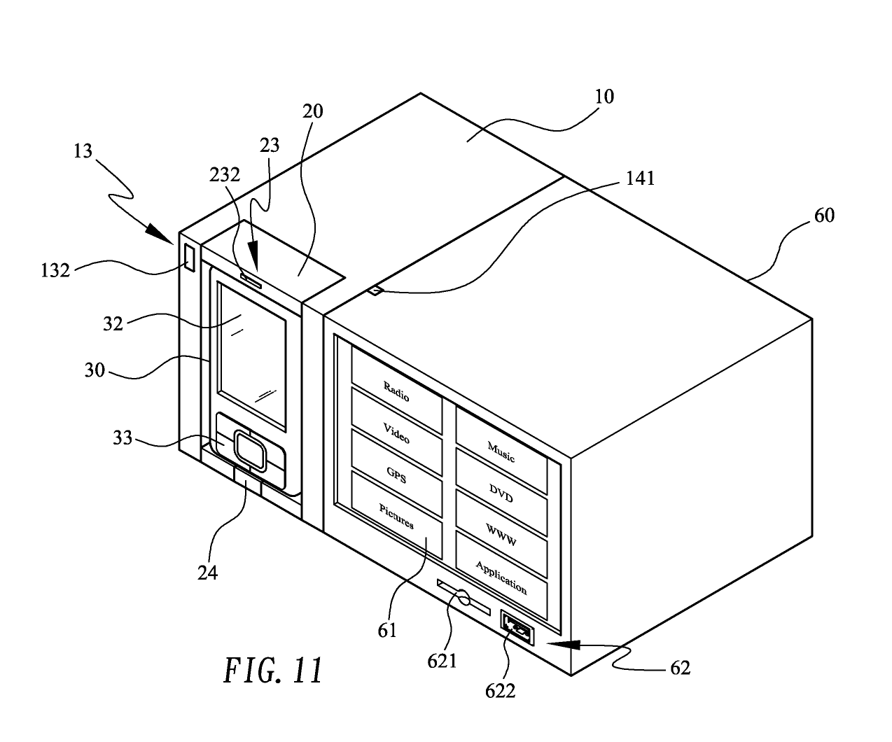

FIG. 11 shows another preferred embodiment of the present invention. In this embodiment, the supporting enclosure 10 and the intermediate mount 20 are so arranged that the mobile communication device 30 is coupled to the intermediate mount 20 in an upright position. In this case, the supporting enclosure 10 is assembled to two compartments provided behind the dashboard of the car, and the locating unit 141 and the connector unit 142 electrically connected to the connector 12 that are provided on the connecting face 14 of the supporting enclosure 10 are also sized equal to two compartments behind the dashboard. The supporting enclosure 10 can be externally connected with a display device 60 via the locating unit 141 and the connector unit 142. The display device 60 has a touch display panel 61, on which a user can touch to control different operations or functions of the present invention. A group of external insertion slots 62 is provided below the touch display panel 61.

In the illustrated preferred embodiment, the group of external insertion slots 62 includes more than one SD memory card slot 621 and more than one RAM (flash drive) socket 622. However, it is understood the above description is made only for exemplification without the intention of restricting the scope of the present invention. That is, in the group of external insertion slots 62, the memory card slot 621 can be otherwise, for example, a SDHC (Security Digital High Capacity) card slot or a SSFDC (Solid State Floppy Disc Card) slot, and the socket 622 can be otherwise, for example, an IEEE 1394 socket.

To use the present invention in a car, first pivotally turn the pivotable coupler 24 on the intermediate mount 20 outward toward the user, and then align the socket 35 on the mobile communication device 30 with the pivotable coupler 24 and connect the mobile communication device 30 to the pivotable coupler 24. Thereafter, the mobile communication device 30 is pivotally turned into the second receiving space 22 of the intermediate mount 20 to engage the slot 31 with the second spring plate 231 of the second spring fastener assembly 23 and accordingly be retained in the second receiving space 22. Finally, install the intermediate mount 20 in the first receiving space 11 of the supporting enclosure 10, so that the intermediate mount 20 is retained in the first receiving space 11 by the first spring plate 131 of the first spring fastener assembly 13. At this point, the mobile communication device 30 is electrically connected to the amplifier and the power supply module inside the supporting module 10.

In conclusion, in the present invention, a mobile communication device is assembled to an intermediate mount configured corresponding to the mobile communication device, and the intermediate mount is electrically connected to a supporting enclosure internally provided with an amplifier and a power supply module, so that the mobile communication device cooperates with a built-in car stereo system to output multimedia AV contents and is charged at the same time. With these arrangements, the mobile communication device can be used in a car to provide good applicability. Further, the supporting enclosure can be connected at one side to a holder or an operation control module. With the holder, a GPS navigator device can be conveniently mounted thereto for use. And, the operation control module allows a user to control the operations or functions of the present invention simply by touching or pushing keys provided thereon. With the present invention, a car stereo system is functionally enhanced.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A car stereo unit with removably coupled mobile communication device, comprising:
a supporting enclosure for installing in a car behind a dashboard thereof, the supporting enclosure being inward recessed at a front portion to provide a first receiving space and internally provided with a power supply module as well as an amplifier connected to a car stereo system built in the car; a connector being provided in the first receiving space to electrically connect with the amplifier and power supply module; and a first spring fastener assembly being provided on a first side wall of the supporting enclosure adjoining the first receiving space to locate at one side of the connector;
an intermediate mount being sized and shaped corresponding to the first receiving space for removably assembled to and held in the first receiving space via the first spring fastener assembly; the intermediate mount being provided on a back wall thereof with a mating connector corresponding to and electrically connected to the connector on the supporting enclosure, and being formed at a front portion thereof with a second receiving space; a second spring fastener assembly being provided on a third side wall of the intermediate mount adjoining the second receiving space, and a pivotable coupler being provided on a fourth side wall of the intermediate mount opposite to the third side wall and the second spring fastener assembly and electrically connected to the mating connector; and
a mobile communication device being removably assembled to and received in the second receiving space of the intermediate mount, the mobile communication device being provided on one end with a socket for electrically connecting to the pivotable coupler, and on another end opposite to the socket with a locating slot for engaging with the second spring fastener assembly; the mobile communication device being internally provided with a control unit electrically connected to the socket, and the control unit having at least a multimedia player module, which works with the amplifier inside the supporting enclosure to output sound, so that the built-in car stereo system produces a sound source.

2. The car stereo unit with removably coupled mobile communication device as claimed in claim 1, wherein the second receiving space formed on the intermediate mount is differently sized and shaped to be adaptable to differently-sized mobile communication devices.

3. The car stereo unit with removably coupled mobile communication device as claimed in claim 1, wherein the first spring fastener assembly includes a first spring plate located in the first receiving space on the first side wall and a first push button located on a front end surface of the first side wall; the first spring plate being provided to retain the intermediate mount in the first receiving space, and the first push button, when being pushed, pressing against the first spring plate to release the first spring plate from the intermediate mount.

4. The car stereo unit with removably coupled mobile communication device as claimed in claim 1, wherein the second spring fastener assembly includes a second spring plate located in the second receiving space on the third side wall and a second push button located on a front end surface of the third side wall; the second spring plate being provided to retain the mobile communication device in the second receiving space, and the second push button, when being pushed, pressing against the second spring plate to release the second spring plate from the mobile communication device.

5. The car stereo unit with removably coupled mobile communication device as claimed in claim 1, wherein the mobile communication device has a display and a plurality of keys provided on a front face thereof, allowing a user to operate the keys to control the control unit of the mobile communication device.

6. The car stereo unit with removably coupled mobile communication device as claimed in claim 1, wherein the mobile communication device is provided on a front face with a display, which includes a display panel and a touch panel, allowing a user to touch the display and control the control unit of the mobile communication device.

7. The car stereo unit with removably coupled mobile communication device as claimed in claim 1, wherein the control unit of the mobile communication device further includes a multifunctional module as a combination of at least any two of a digital image player module, a digital data processor module, a broadcast receiver module, a mobile communication module, and a Bluetooth communication module.

8. The car stereo unit with removably coupled mobile communication device as claimed in claim 1, wherein the pivotable coupler on the intermediate mount and the socket on the mobile communication device are implemented as corresponding connection interfaces selected from the group consisting of a universal serial bus (USB) interface and an IEEE 1394 interface.

9. The car stereo unit with removably coupled mobile communication device as claimed in claim 1, wherein the supporting enclosure has a second side wall opposite to the first side wall, and the second side wall externally defining a connecting face, on which a locating unit and a connector unit electrically connected to the connector are provided at predetermined positions.

10. The car stereo unit with removably coupled mobile communication device as claimed in claim 9, further comprising an operation control module; the operation control module being provided with a groove corresponding to the locating unit and a mating connector unit corresponding to the connector unit, such that the operation control module is assembled to the supporting enclosure through engagement of the groove and the mating connector unit with the locating unit and the connector unit, respectively, and is electrically connected to the connector unit and accordingly the mobile communication device, allowing a user to control playing functions of the mobile communication device via the operation control module.

11. The car stereo unit with removably coupled mobile communication device as claimed in claim 9, further comprising a holder; the holder being assembled to the connecting face of the supporting enclosure via the locating unit and the connector unit for holding a global positioning system (GPS) navigator device thereto.

12. The car stereo unit with removably coupled mobile communication device as claimed in claim 11, wherein the holder includes a circular supporting seat screwed thereto, and the circular supporting seat having a smooth and flat locating face, to where the navigator device is attached by way of vacuum suction.

13. The car stereo unit with removably coupled mobile communication device as claimed in claim 9, further comprising a display device; the display device being assembled to the connecting face of the supporting enclosure via the locating unit and the connector unit, and having a touch display panel and a group of external insertion slots; the touch display panel allowing a user to touch it for controlling different operations or functions of the car stereo unit, and the group of external insertion slots is located below the touch display panel.

14. The car stereo unit with removably coupled mobile communication device as claimed in claim 13, wherein the group of external insertion slots includes more than one memory card slot and more than one connection socket.
